(19) United States
(12) Patent Application Publication
(10) Pub. No.: US 2005/0154639 A1
(43) Pub. Date: Jul. 14, 2005

(54) BUSINESS METHOD AND MODEL FOR INTEGRATING SOCIAL NETWORKING INTO ELECTRONIC AUCTIONS AND ECOMMERCE VENUES.

(76) Inventor: Karl Douglas Zetmeir, Overland Park, KS (US)

Correspondence Address: Karl Zetmeir, 11909 Bluejacket, Overland Park, KS, 66213, US

(21) Appl. No.: 10/905,528

(22) Filed: Jan. 7, 2005

Related U.S. Application Data
(60) Provisional application No. 60/535,140, filed on Jan. 9, 2004.

(51) Int. Cl. G06F 17/60

(52) U.S. Cl. 705/14

(57) ABSTRACT

This invention creates an enhanced marketing system for Online Auctions and ECommerce websites to further provide secondary reasons for current Members to be active with the website. It also provides for the acquisition, activation and retention of new Members that may come to them by way of the 3^{rd} party Organizations that currently have a membership they can influence to become active with the Online Auction website. This invention provides for the presence of an accounting system for awarded incentive points, accessibility to that accounting system and the distribution of those points either through direct redemptions, transfer to other Members or transfer to 3^{rd} party Organizations.

### BACKGROUND OF THE INVENTION

1. Field of the Invention

This invention relates to the integration of social networks with an electronic auction or eCommerce (terms used interchangeably) website. The invention specifically relates to enhancing marketing activity within the electronic auction environ by increasing the amount of time users spend at the site and provides users with an ability to view recordation of incentive accumulations and access accounting for the donation and/or redemption of incentives earned if provided by the commercial enterprise.

2. Discussion of Background

Online auctions have become extremely popular to millions of consumers. The industry is dominated by eBay, Inc. having approx. 98% of electronic auction participation and activity. Numerous other auction sites including those offered by Amazon.com, Yahoo.com, Bidville.com and Microsoft.com have not been successful in overcoming the “first mover advantage” of eBay. This is due in part to a lack of site mechanics or business model differentiation adequate to attract large numbers of prospective Sellers, Bidders and Buyers.

Likewise, social networks such as Friendster.com, Ryze.com, LinkedIn.com and many others have been very popular with consumers for social dating and making professional contacts. However, that none of these social networks have been able to bring forth a viable business model to support their networks, many of which are now used by millions of registered users, is well known and frequently discussed in the eCommerce marketing community.

Heretofore many of these social networks have attempted to support their efforts by charging users for memberships, sales of advertising to third party advertisers or a combination of both. Unfortunately the desire of the consuming internet public is online services should be available free of charge, even though this may not be realistic, and attempts to charge for various social network fees have not been successful. (Cite 5,8)

This invention integrates the technique of social networks, which hold the promise of access to millions of consumers by marketers, with a viable eCommerce venue such as an Online Auction which needs plentiful and frequent visitations, bidding and buying activity to satisfy participating sellers and support their marketing and revenue goals.

Inherent in any group of consumers is their aggregate purchasing power that may be directed for goods and services offered by an eCommerce marketer or for items offered as listings within an Online Auction.

The use of incentive points given to participants of an Online Auction whether or not they are the successful winning bidders is disclosed by this inventor under another Provisional Patent: 60/575,518.

Using the social network profile page, users can gift earned incentive points to other social network members. Whether this is to an individual or a single donation to a for-profit or a not-for-profit Organization, the user can designate the donee and the amount of the incentive points gift. Additionally, if the user has an Organization, i.e. church, alma mater, they wish to continually donate all or a portion of their earned incentives, that wish is structured from the social network preference page.

Therefore the object of this invention is to create an affinity between visitors and/or users of an Online Auction or eCommerce site through a site-sponsored social network providing secondary benefits (other than participating in auction listings or purchases) including social networking (romantic social contacts (dating) and friendships) as well as the opportunity to earn, redeem and donate incentives earned through their auction participation activities.

There are many patents and patent applications replete with various aspects of contextual and behavioral interfaces in the software architecture of social networks. It is not the intent of this invention to restate or redefine various social network or Online Auction architectures. Rather, this invention provides a tool to combine the popularity of Online Auctions with the popularity of social networks resulting in an expanded marketing appeal of both.

The concept of social networking, incenting purchases and “member get a member” affinity marketing efforts has existed many years. This inventor has personally been involved in many such marketing efforts through direct mail solicitation efforts. However, the internet has brought new capabilities where users can communicate with one another rather than just the Sponsor Organization. This invention allows Online Auction and eCommerce sites to build traffic, create a long-lasting affinity with that traffic, monetize that traffic by indirectly providing non-monetary incentives and a vehicle to view and manipulate monetary incentive accounts all to the benefits of users and the auction or eCommerce site.

It is also not the purpose of this Application to define a double entry accounting system used to track the ingress and egress of incentive points by users as the disciplines involved in double entry accounting are well known in the field of accounting.

### PRIOR ART

U.S. Pat. No. 6,175,831 by Weinreich et al and assigned to Six Degrees, Inc. . . . the inventor describes a networking architecture that has been copied an enhanced by many social networks. While the 831 patent describes a personal profile created by a user and the ability to search other registered users' profiles, it does not describe linkage to an accounting system that maintains the earning and dispensing of incentive points for that user as a marketing enhancement for an unrelated commercial enterprise. Weinreich does mention a website could be created where users could list items for “sale, hire, rent, etc” but never mentions earning incentives for auction activities or disposition of those incentives solely due to their participation in a third party eCommerce site with no purchase required. Weinreich does not teach an ancillary accounting system to track points earned and their subsequent dispersal.

There have been Patent Applications published after the above referenced Provisional Patent date, some of which were filed and published after the filing. For the sake of disclosure I am citing:

20040193489 describes a system of earning incentive points offline and then going to an online site to redeem the points with the promotion sponsor. This invention does not allow for the earning of points online for Online Auction participation activities that can be dispersed discriminately by user discretion online.

20030093405 describes enhanced profiling and search preferences,

“However, to the best of the inventor's knowledge there is no way to systematically search in these networks for compatible dates by attributes such as for example education, general background, appearance, attitudes, and personality, or by reciprocal compatibility in any of the above mentioned attributes”

Inventor Mayer suggests networks can “start charging payments in the future, after a sufficient number of users have also started using the dating option.” Mayer never suggests any affiliation with an auction or eCommerce site or the use of incentive points.

20040148275 describes methodologies to maintain privacy of personal information. It does not address any method of monetizing the aggregate buying power of the social network group.

20030158855 describes a “context association system” “The context association system allows a user to view and assign searchable metadata and to retrieve documents, objects or files that match selected metadata.” There are no references to a business model to fund the network.

20030220980 describes “a system for building a reference hierarchy within a computer network-based community according to a user-to-user ally association function.” This reference (non-final rejection issued) focuses on a social network infrastructure and says nothing about generating revenues to support the network.

Obviously there has been great thought and efforts put forth by numerous inventors attempting to refine the initial Six Degrees, Inc. (831) patent. Invariably all fall short in suggesting any method, technique or even concern that site owners and users have tools to equitably reward all concerned for the efforts they have invested in creating either an eCommerce venture or participating in same.

### BRIEF DESCRIPTION OF THE DRAWINGS

FIG. 1 is a Drawing of a simple Online Auction configuration with Registered Users (200) interacting with the Online Auction or ECommerce website. (100)

FIG. 2 is a Drawing of an Online Auction or ECommerce website (100) sponsoring a social network (300) for their Registered User Members. (200)

FIG. 3 is a Drawing of an Online Auction or ECommerce website (100) that sponsors a social network (300) for their Registered Users (200) and provides incentive points accounting (400) based upon the Users' participation in the Sponsor's website.

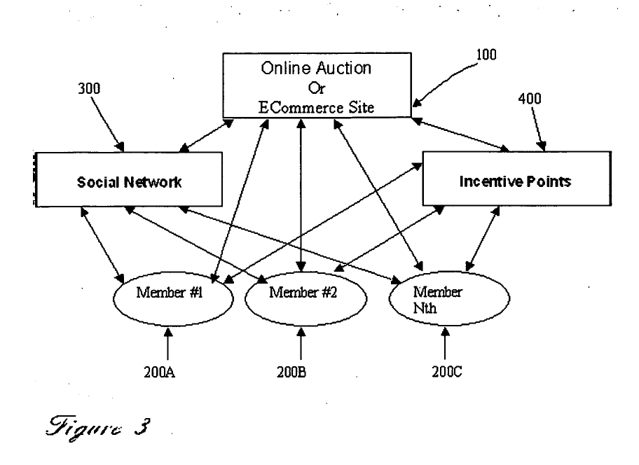

FIG. 4 is a Drawing of an Online Auction or ECommerce website (100) that sponsors a social network (300) for their Registered Users (200), provides incentive points and accounting (400) based upon Users' participation an allows Users to donate earned incentive points to a 3^{rd} party Organization (500) of their choice.

### DETAILED DESCRIPTION OF THE INVENTION

This invention provides for the enhancement of an Online Auction or ECommerce Marketing efforts through sponsoring a social network, providing incentive points recordation (400) to Registered Users (200) on site activities and providing a framework (400) for assigning earned points to other members or their designated 3^{rd} party Organizations. (500)

This invention uses a computer network for World Wide Web access to the System from a plurality of Registered Users who accesses the System Web Site or the Users can connect directly to the System. Accessing the System Web Site can be accomplished directly through a communication means such as a direct connection, an intranet, a local Internet Service Provider, often referred to as ISPs, or through an on-line service provider like CompuServe, Prodigy, American Online, etc. or Wireless devices using services like AT&T or Sprint.

The Registered Users contact the System Web Site 100 using an informational processing system (Client) capable of running an HTML compliant Web browser such as Microsoft's Internet Explorer, Netscape Navigator, Lynx and Mosaic. A typical system that is used is a personal computer with an operating system such as Windows 95, 98 or ME, NT, 2000, XP or Linux, running a Web browser. The exact hardware configuration of computer used by the Clients 20, the brand of operating system or the brand of Web browser configuration is unimportant to understand this present invention. Those skilled in the art can conclude that any HTML (Hyper Text Markup Language) compatible Web browser is within the true spirit of this invention and the scope of the claims.

In one preferred embodiment of the invention, the Registered Users connect to the System Web Site. In the preferred embodiment the system has numerous web pages. The information in the web pages are in HTML format via the HyperText Transport Protocol (http) and on Server System. The System includes software to allow viewing of web pages, commonly referred to as a Web Browser, such as Communicator available from Netscape Communications Corp. or Internet Explorer available from Microsoft Corp. The user system is capable of accessing web pages located on Server System.

Output can include a graphical user interface, hardcopy, facsimile, e-mail, messaging or other communication with any humanly or machine discernable data and/or artifacts. In some embodiments, output can include transmitting the risk variable related data to a designated recipient, any humanly or machine discernable data and/or artifacts.

The data processing System allows for secure input, data transfer and storage of a wide array of information. The System allows and handles the direct transfer of security rights and the broker is given the ability to trade only as an agent for the client. The input, data exchange and storage of the data is achieved by electronic data transmission, thus eliminating the need for paper logs. In a first embodiment of the invention, as further discussed below, means for processing data is provided which includes computer software installed at various locations within the data processing system. In a second embodiment of the invention, the data processing system has means for processing data which is installed on a web server computer; therefore, there is but one necessary installation of the means for processing data, and users log on to a website and conduct functions within the data processing system through the web server. The first embodiment can also be referred to as a Windows™ version, and the second embodiment can be referred to as a web browser version. The functionality of both embodiments is essentially the same; however, the second embodiment or the web browser version may incorporate some additional enhancements, as further discussed below. The data processing system in both embodiments utilizes a secure environment to transmit all data through encryption/decryption. The data processing system further provides for an audit trail of modifications made to the recorded data.

The data processing System includes computer processing means for processing data, storage means for storing data on a storage medium, and communication means for transferring data in a secure environment.

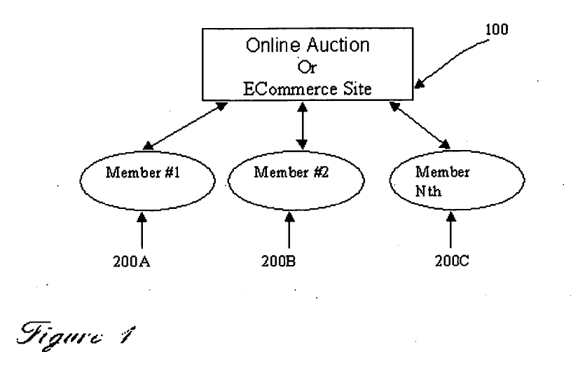

FIG. 1 shows a simple Sponsor/Client relationship with no incentives for Members (Registered Users) other than their right to participate, listing, bidding and buying, in the Online Auction offerings. This is the limited marketing methodology in use today.

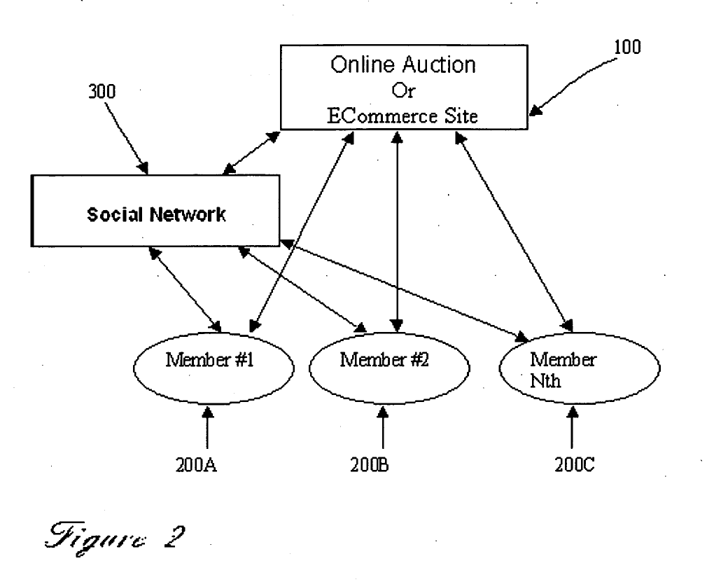

By sponsoring a social network for Members or affiliating with an existing social network, FIG. 2, there is a secondary benefit to Members which is the interaction with other Members on a one to one basis as may be provided within the framework refinements of the social network structure. If a Member does not choose to belong to the Social Network that is his/her option. Access to the social network is always made using the Online Auction or ECommerce website as a gateway, requiring traffic entering the social network to also pass through the sponsor website by requiring the entry of a password at the Sponsor website.

If the Online Auction enterprise also offers incentive points to Members, an accounting system (400) to provide online tracking is sponsored by the Online Auction. As points are earned, the points are distributed to each Member's account. A link to each individual Member's account and point accumulation and distribution are accessed through the Profile Page within the social network (300) or through the sponsor's individual accounting page in the event he/she does not join the social network. The accounting recordation includes, item number, type of activity, points earned, type of dispersement, date of dispersement, number of points dispersed and other necessary accounting functions related to the accountability of incentive points.

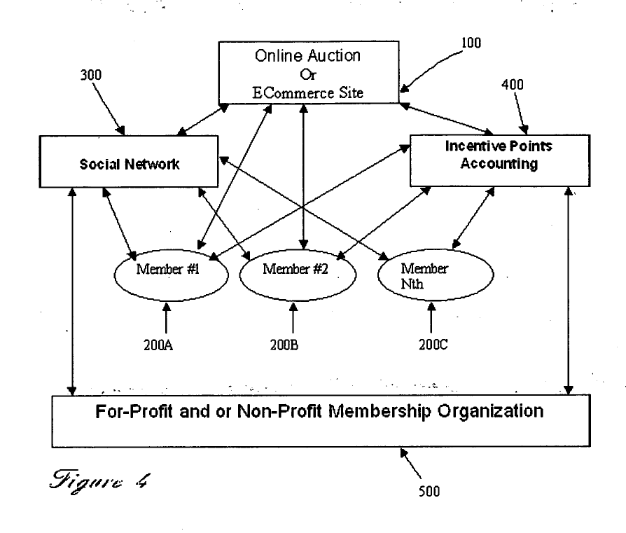

FIG. 4 indicates a 3^{rd} party Organization (500) that is involved in sponsoring and promoting a social network (300) associated with, and in conjunction with, an Online Auction (100) to their respective proprietary membership (alumni, subscribers, donors, etc.) in return for the opportunity to have their membership donate incentive points in all or part back to their Organization. An ongoing and automatic contribution designation is made from the social network Preference Page and is easily changed.

Points are redeemable by Members or donee Organizations for cash, products or services.

Points are also assignable from one Member to another Member (200) through the social network architecture. (300) Each time a transfer is made a confirmation is made via the registered email a Member has provided, requiring him/her to confirm with a password, the accuracy of the point transfer. Thus, a secure transfer is made and notated on the Member's Point account.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. Methodology of associating a social network with a commercial enterprise comprising: a commercial enterprise using a social network to promote said commercial enterprise.

2. A system according to claim 1, in which said social network comprises a software architecture.

3. A system according to claim 1, in which said social network comprises an existing social network that said commercial enterprises affiliates with.

4. A system according to claim 3, in which said social network comprises a software architecture.

5. A system according to claim 2, in which said software architecture includes a Personal Profile page allowing the entry of demographics and personal attributes.

6. A system according to claim 2, in which said software architecture includes a Preferences Page allowing the individual's control over privacy, access to Member information and continual distribution of earned incentive points.

7. A system according to claim 1, in which Said commercial enterprise is an Online Auction venue.

8. A system according to claim 7, in which said online auction venue allows individuals to list, bid and purchase listed items.

9. A system according to claim 1, in which Said commercial enterprise is an ECommerce site operating to provide for the sales of products.

10. A system according to claim 1, in which Said commercial enterprise is an ECommerce site operating to provide for the sales of services.

11. A system according to claim 1, in which Said commercial enterprise is an ECommerce site.

12. A system according to claim 1 which provides for the accountability of earned incentive points by using a double entry accounting system indicating the date, method and amount of incentive points earned and indicating the dispersal of incentive points per the confirmed instructions of Members.

13. A system according to claim 1 that provides access to the accounting system through the Personal Profile and Preference pages of said social network.

14. A system according to claim 1 which provides access to the accounting system through the Member Account Page of a sponsoring website.

15. A system according to claim 1 which provides for an affiliation of an External 3^{rd} Party Organization to the Sponsor website.

16. A system according to claim 15 in which a plurality of external organizations promotes the Sponsoring Website to their existing and future Membership.

17. A system according to claim 15 in which a plurality of external organizations may access the incentive point accounting system to monitor the activity of their Membership.

18. A system according to claim 15 in which a plurality of external organizations may view accountability of their point redemption through an accounting system.
